(19) United States
(12) Patent Application Publication
(10) Pub. No.: US 2017/0277291 A1
(43) Pub. Date: Sep. 28, 2017

(54) TOUCH SENSING ELECTRODE INTEGRALLY FORMED WITH POLARIZING PLATE, DISPLAY DEVICE COMPRISING SAME, AND MANUFACTURING METHOD THEREFOR

(71) Applicant: DONGWOO FINE-CHEM CO., LTD., Iksan-si, Jeollabuk-do (KR)

(72) Inventors: Jaehyun LEE, Uiwang-si (KR); Byung Jin CHOI, Incheon (KR); Dong Pil PARK, Incheon (KR); Yong Won SEO, Hwaseong-si (KR); Byung Hoon SONG, Gunpo-si (KR)

(73) Assignee: DONGWOO FINE-CHEM CO., LTD., Iksan-si, Jeollabuk-do (KR)

(21) Appl. No.: 15/511,074

(22) PCT Filed: Sep. 22, 2015
(86) PCT No.: PCT/KR2015/009913

§ 371 Date: Mar. 14, 2017

(30) Foreign Application Priority Data
Sep. 25, 2014 (KR) 10-2014-0128592
Mar. 27, 2015 (KR) 10-2015-0043560

(51) Int. Cl. G06F 3/041; G02B 5/30

(52) U.S. Cl. CPC G06F 3/041; G02B 5/3083; G06F 2203/04102; G06F 2203/04103

(57) ABSTRACT

The present invention relates to a touch sensing electrode with a polarizing plate, a display device comprising the same, and a method for fabricating the same.

The touch sensing electrode with a polarizing plate according to the present invention comprises a touch sensing electrode capable of being folded and unfolded on its folding axis; a retardation film disposed on the touch sensing electrode and having a slow axis that forms an inclined angle with the folding axis; and a polarizing plate disposed on the retardation film.

### TECHNICAL FIELD

The present invention relates to a touch sensing electrode with a polarizing plate, a display device comprising the same, and a method for fabricating the same. More particularly, the present invention relates to a touch sensing electrode with a polarizing plate, which can be applied in a flexible display or a foldable display, a display device comprising the same, and a method for fabricating the same.

### BACKGROUND ART

Recently, with the rapid growth of semiconductor technology, there are dramatically increasing demands on display device to reduce their size and weight and to have good performance.

Also, various kinds of electronic displays have been developed for the visual delivery of information in information-oriented society, and portable displays are gaining attention with the development of mobile communications technology.

Such a display device has been changed from a cathode ray tube (CRT) to a liquid crystal display (LCD), a plasma display panel (PDP), an organic light emitting diode (OLED) and the like.

Furthermore, a flexible display and a foldable display made of a polymer film instead of a glass substrate have been actively researched since they are thinner and lighter than conventional panels and they can be bent or folded and unfolded on the folding axis.

However, the existing foldable displays (according to the prior art) undergo the decrease of anti-reflective property in the folding part when folded on the folding axis, from which there is a difference of anti-reflective property between the folding part and the unfolding part, making it the visibility of the folding part poor and the overall performance of the displays be deteriorated.

### DISCLOSURE OF INVENTION

### Technical Problem

The present invention is to solve the above problems, and therefore, an object of the present invention is to provide a touch sensing electrode with a polarizing plate, which can maintain each anti-reflective property of a folding part and an unfolding part in the equivalent level in a foldable display, thereby improving visibility, a display device comprising the same, and a method for fabricating the same.

Another object of the present invention is to provide a touch sensing electrode with a polarizing plate, in which a retardation film has a slow axis to form an inclined angle with the folding axis of a foldable display, a display device comprising the same, and a method for fabricating the same.

### Technical Solution

According to an aspect of the present invention, there is provided a touch sensing electrode with a polarizing plate, comprising: a touch sensing electrode capable of being folded and unfolded on its folding axis; a retardation film disposed on the touch sensing electrode and having a slow axis that forms an inclined angle with the folding axis; and a polarizing plate disposed on the retardation film.

The inclined angle may range from 40 to 50°, preferably 45°.

The retardation film may have a thickness of 100 μm or less, preferably 50 μm or less.

Also, the retardation film may have inverse wavelength dispersibility that provides a low refractive index for short wavelength area and a high refractive index for long wavelength area.

The touch sensing electrode with a polarizing plate may have a gap of phase differences of 10 nm or less, preferably 5 nm or less between a folding part and an unfolding part when the touch sensing electrode is folded on the folding axis.

According to another aspect of the present invention, there is provided a method for fabricating the touch sensing electrode with a polarizing plate according to the present invention, comprising: laminating a retardation film on a substrate; forming a touch sensing electrode capable of being folded and unfolded on its folding axis on the retardation film; delaminating the retardation film with the touch sensing electrode from the substrate; and attaching a polarizing plate to the retardation film with the touch sensing electrode, wherein the retardation film has a slow axis that forms an inclined angle with the folding axis.

According to still another aspect of the present invention, there is provided a method for fabricating the touch sensing electrode with a polarizing plate according to the present invention, comprising: forming a touch sensing electrode capable of being folded and unfolded on its folding axis on a substrate; transferring the touch sensing electrode on a retardation film; and attaching a polarizing plate to the retardation film with the touch sensing electrode, wherein the retardation film has a slow axis that forms an inclined angle with the folding axis.

In the present invention, the step of forming the touch sensing electrode comprises carrying out a photolithography process of the touch sensing electrode so that the folding axis forms an inclined angle with respect to the longitudinal direction of the substrate having a square shape.

### Advantageous Effects

The touch sensing electrode with a polarizing plate according to the present invention can maintain each anti-reflective property of a folding part and an unfolding part in the equivalent level in a foldable display, thereby improving visibility and eventually enhancing display performances.

Also, the touch sensing electrode with a polarizing plate according to the present invention can improve the anti-reflective property of a folding part by forming the slow axis of a retardation film that forms an inclined angle with the folding axis of a foldable display.

### DESCRIPTION OF DRAWINGS

FIG. 1 is a configuration view of a touch sensing electrode with a polarizing plate according to one embodiment of the present invention.

FIG. 2 shows a touch sensing electrode with a polarizing plate in its unfolded state.

FIG. 3 shows a touch sensing electrode with a polarizing plate in its folded state.

FIG. 4 shows a touch sensing electrode with a polarizing plate, in which the absorption axis of a polarizer is parallel with a folding axis and the slow axis of a retardation film forms an inclined angle of 45° with the folding axis.

FIG. 5 shows a touch sensing electrode with a polarizing plate, in which the absorption axis of a polarizer is perpendicular to a folding axis and the slow axis of a retardation film forms an inclined angle of 45° with the folding axis,

FIG. 6 shows a touch sensing electrode with a polarizing plate, in which the absorption axis of a polarizer forms an inclined angle of 45° with the folding axis and the slow axis of a retardation film is parallel with the folding axis.

FIG. 7 shows a touch sensing electrode with a polarizing plate, in which the absorption axis of a polarizer forms an inclined angle of 45° with the folding axis and the slow axis of a retardation film is perpendicular to the folding axis.

FIG. 8 schematically shows a process of fabricating a conventional touch sensing electrode with a polarizing plate by a method known in the art.

FIG. 9 schematically shows a process of fabricating a touch sensing electrode with a polarizing plate according to one embodiment of the present invention by a method known in the art.

FIG. 10 schematically shows a process of fabricating a touch sensing electrode with a polarizing plate according to one embodiment of the present invention by the method of the present invention.

### MODE FOR INVENTION

The present invention will be described more fully hereinafter in detail with reference to the accompanying drawings.

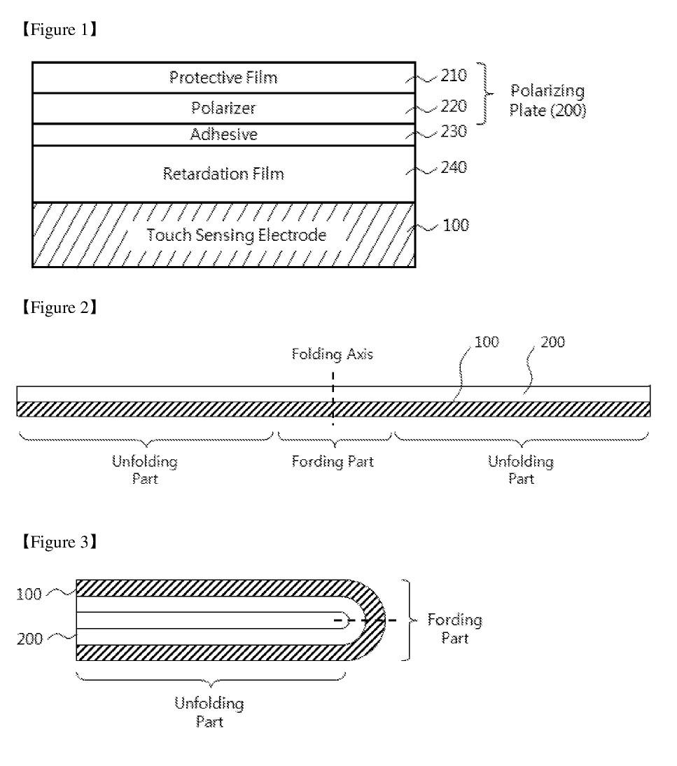

FIG. 1 is a configuration view of a touch sensing electrode with a polarizing plate according to one embodiment of the present invention. Referring to FIG. 1, a touch sensing electrode with a polarizing plate according to one embodiment of the present invention comprises a touch sensing electrode 100 that senses the touch of a user, and a retardation film 240, an adhesive 230, a polarizer 220 and a protective film 210 on the touch sensing electrode.

As described in Korean Patent No. 10-1401050, the touch sensing electrode 100 is configured to have a first pattern for sensing the position of an x-coordinate on a display and a second pattern for sensing the position of a y-coordinate on the display, which transmit the x-coordinate and the y-coordinate sensed from the touch of a user into a controlling unit (a microprocessor), thereby detecting the positions touched on a display. Besides the ways described above, the touch sensing electrode 100 in the present invention may be applied in various ways known in the art.

A polarizing plate 200 may consist of the polarizer 220 and the protective film 210, to which the retardation film 240 is attached through the adhesive 230 to form a retardation film-attached polarizing plate, as shown in FIG. 1, For reference, besides the form of the polarizing plate as shown in FIG. 1, various forms thereof known in the art may be used in the present invention.

<Protective Film>

The protective film 210 is not particularly limited if it has good transparency, mechanical strength, thermal stability, moisture-shielding property, and isotropicity.

For example, the protective film may be a thermoplastic film made of polyester resins such as polyethylene terephthalate, polyethylene isophthalate and polybutylene terephthalate; cellulose resins such as diacetyl cellulose and triacetyl cellulose; polycarbonate resins; acrylate resins such as polymethyl (meth)acrylate and polyethyl (meth)acrylate; styrene resins such as polystyrene and acrylonitrile-styrene copolymer; polyolefin resins such as polyethylene, polypropylene, polyolefin having a cyclic or norbonene structure, and ethylene-propylene copolymer; vinyl chloride resins; polyamide resins such as nylon and aromatic polyamide; imide resins; polyether sulfone resins; sulfone resins; polyether ketone resins; polyphenylene sulfide resins; vinyl alcohol resins; vinylidene chloride resins; vinyl butyral resins; allylated resins; polyoxymethylene resins; epoxy resins; and a blend thereof. Also, a film made of thermally curable or UV curable resins such as (meth)acrylate, urethane, epoxy and silicon resins may be used. Among these, cellulose films being surface-treated by alkali saponification, triacetyl cellulose (TAC) Film is preferably used in terms of polarizing property and durability. Further, the protective film may have the function of optical compensation.

<Polarizer>

The polarizer 220 is an optical film that converts a beam of incident natural light into one with a single linear polarization, and is not particularly limited if it can carry out a general polarization function in the art.

For example, a polarizer obtained by adsorbing iodine or a dichroic dye on a polyvinyl alcohol (PVA) film, followed by stretching in a certain direction, or a thin polarizing plate comprising conductive lattices of fine patterns with polarization function on a transparent substrate and an insulating layer coated on the peak and the valley of the lattices may be used.

The polyvinyl alcohol resin used in preparation of the polarizer may be obtained by bringing a polyvinyl acetate resin into saponification. The polyvinyl acetate resin may be polyvinyl acetate being a homopolymer of vinyl acetate, or a copolymer of vinyl acetate and other monomer copolymerizable with the vinyl acetate. Examples of the other monomer copolymerizable with the vinyl acetate may include unsaturated carboxylic acid, unsaturated sulfonic acid, olefin, vinyl ether, and ammonium group-containing acrylamide monomers. Also, the polyvinyl alcohol resin may be modified, e.g., polyvinyl formal or polyvinyl acetal modified with aldehydes. The degree of saponification of the polyvinyl alcohol resin conventionally ranges from 85 to 100 mol %, preferably 98 mol % or more. Also, the degree of polymerization of the polyvinyl alcohol resin conventionally ranges from 1,000 to 10,000, preferably 1,500 to 5,000.

Such a polyvinyl alcohol resin is prepared in the form of a film and it is used as the polarizer. The film formation of the polyvinyl alcohol resin may be carried out by various methods known in the art, without limitation. The polyvinyl alcohol resin may have a thickness of 10 to 150 μm, but is not limited thereto.

<Adhesive>

The adhesive 230 functions to attach the polarizer 220 to the retardation film 240, and various kinds of adhesives known in the art, e.g., a pressure sensitive adhesive (PSA) may be used.

<Retardation Film>

The retardation film 240 may be obtained by aligning a polymer film uniaxially or biaxially or using other suitable methods.

The polymer film may be made of various polymer compounds, without limitation. Especially, a polymer compound having a high transparency may be used in liquid crystal display devices, and examples of such a compound may include polycarbonate, polyester, polysulfone, polyether sulfone, polystyrene, polyolefin, polyvinyl alcohol, cellulose acetate, polymethyl methacrylate, polyvinyl chloride, polyacrylate-poly vinyl chloride, and polyamide-polyvinyl chloride.

Also, the retardation film may be made of nematic or smectic liquid crystal substances which can be polymerized in situ, preferably nematic liquid crystal substances. For example, the retardation film may be obtained by coating a polymerizable liquid crystal substance on a substrate and bringing it into planar alignment, followed by exposing to heat or UV for polymerization.

In a preferred embodiment of the present invention, the retardation film 240 may be an inverse wavelength dispersible λ/4 retardation film that has a low refractive index for short wavelength area and a high refractive index for long wavelength area, thereby converting the light polarized linearly by the polarizer 220 into circular shape, not oval shape.

FIGS. 2 and 3 are provided to show a touch sensing electrode with a polarizing plate according to one embodiment of the present invention, which comprises a part to be folded by bending and another part to be unfolded when it is applied in a foldable display device. For reference, FIG. 2 shows a touch sensing electrode with a polarizing plate, in which a folding part and an unfolding part are indicated in the unfolded state. Meanwhile, FIG. 3 shows a touch sensing electrode with a polarizing plate, in which a folding part by bending on the folding axis and an unfolding part are indicated in the folded state.

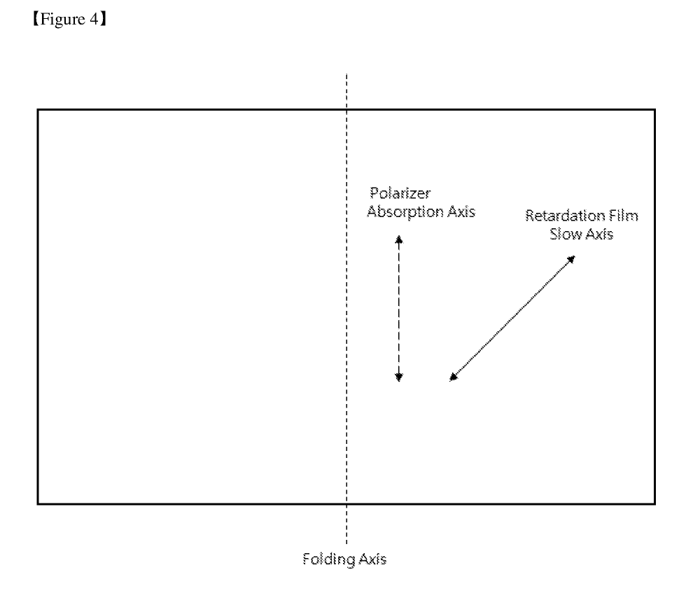

Hereinafter, the present invention will be described more fully hereinafter in detail with reference to FIGS. 4 to 7.

### EXAMPLE 1

A retardation film-attached polarizing plate was prepared in the structure shown in FIG. 1, in which a 25 μm-thick triacetyl cellulose film was used as a protective film, a 22 μm-thick polyvinyl alcohol film was used as a polarizer, a 15 μm-thick pressure sensitive adhesive (PSA) film was used as an adhesive, and a 50 μm-thick λ/4 retardation film (Trade Name: WRS film) having inverse dispersibility was used as a retardation film.

In the polarizing plate, the absorption axis of the polarizer is parallel with a folding axis and the slow axis of the retardation film forms an inclined angle of 45° with the folding axis (FIG. 4).

### EXAMPLE 2

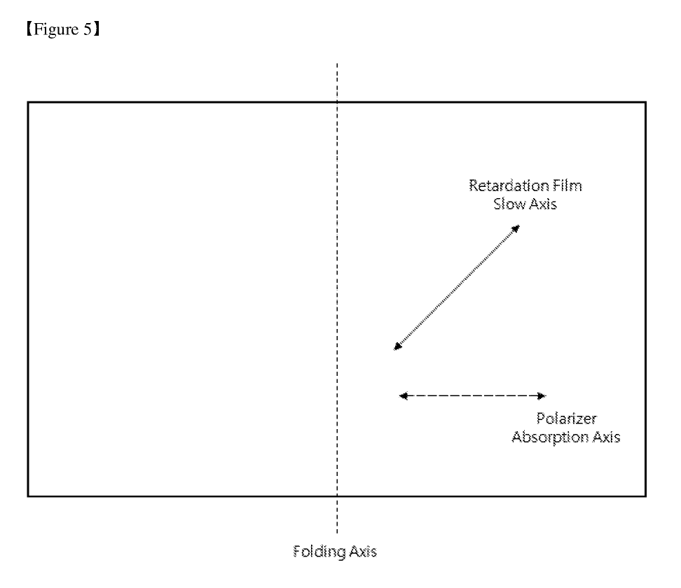

A retardation film-attached polarizing plate was prepared in the same structure and using the same materials as Example 1, except that the absorption axis of the polarizer is perpendicular to a folding axis and the slow axis of the retardation film forms an inclined angle of 45° with the folding axis (FIG. 5).

### COMPARATIVE EXAMPLE 1

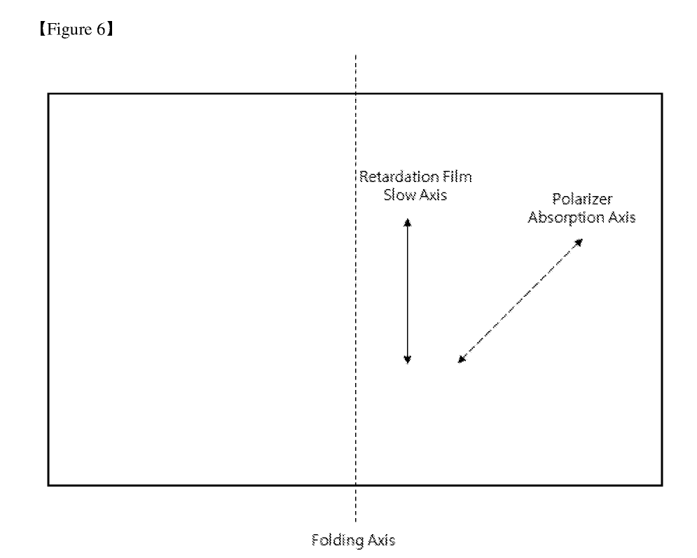

A retardation film-attached polarizing plate was prepared in the same structure and using the same materials as Example I, except that the absorption axis of a polarizer forms an inclined angle of 45° with the folding axis and the slow axis of a retardation film is parallel with the folding axis (FIG. 6).

### COMPARATIVE EXAMPLE 2

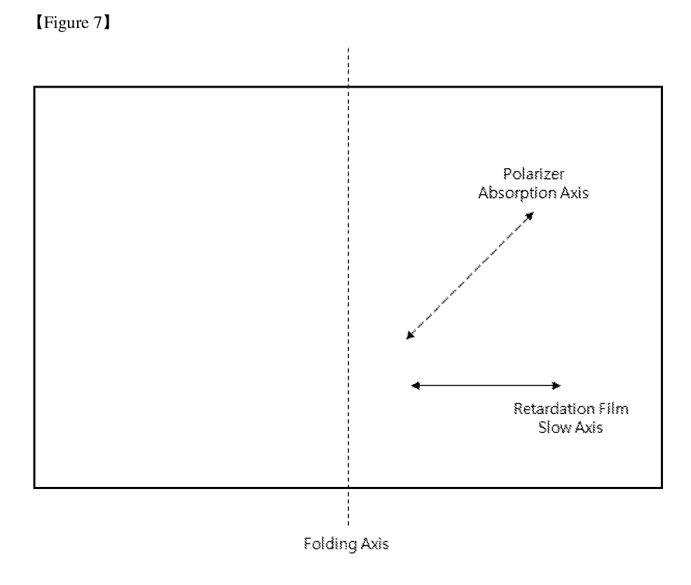

A retardation film-attached polarizing plate was prepared in the same structure and using the same materials as Example 1, except that the absorption axis of a polarizer forms an inclined angle of 45° with the folding axis and the slow axis of a retardation film is perpendicular to the folding axis (FIG. 7).

### EXPERIMENTAL EXAMPLE

The retardation film-attached polarizing plates prepared in Examples 1 and 2 (corresponding to the present invention) and Comparative Examples 1 and 2 were each measured for their front phase differences (Rₒ) and color difference (ΔE_{ab}) between each folding part and each unfolding part, and the results thereof are shown in Table 1.

TABLE 1

| | | | Gap of Phase | |
|---|---|---|---|---|
| | Phase | Phase | Differences | Color Difference |
| | Difference of | Difference of | Between Folding | Between Folding |
| | Folding Part | Unfolding Part | Part and Unfolding | Part and Unfolding |
| | (nm) | (nm) | Part (nm) | Part (ΔE_{ab}) |
| Example 1 | 141.5 | 146.3 | 4.8 | 1.6 |
| Example 2 | 145.8 | 144.9 | −0.9 | 0.5 |
| Comparative | 96.9 | 145.5 | 48.6 | 14.7 |
| Example 1 | | | | |
| Comparative | 176.9 | 148.4 | −28.5 | 9.5 |
| Example 2 | | | | |

From Table 1, it is confirmed that the unfolding parts exhibited equivalent phase difference values for Examples 1 and 2 and Comparative Examples 1 and 2, while the folding parts exhibited a decreased phase difference value when the slow axis of the retardation film is parallel with the folding axis (Comparative Example 1), an increased phase difference value when the slow axis is perpendicular to the folding axis (Comparative Example 2), and particularly, substantially identical values to corresponding unfolding parts when the slow axis of a retardation film forms an inclined angle of 45° with the folding axis (Examples 1 and 2). In this regard, it is preferred that a gap of phase differences between the folding part and the unfolding part is 5 nm or less, at least 10 nm or less.

If the gap of phase differences between the folding part and the unfolding part exceeds 10 nm, it causes the difference of reflected color, which will be visually confirmed when a color difference (ΔE_{ab}) between the folding part and the unfolding part exceeds 3. For reference, ΔE*_{ab} and ΔE*ₙᵥ refer to definitions of Uniform Color Space provided in 1976, and among these definitions, ΔE*_{ab} is widely used. For example, ΔE*_{ab} of less than 3 is used as a reference that a color difference cannot be visually confirmed.

Therefore, when the slow axis of a retardation film forms an inclined angle of 40 to 50° , preferably 45° with the folding axis, the gap of the phase differences between each folding part and each unfolding part is lowered to provide substantially identical properties (e.g., anti-reflection), thereby increasing visibility and enhancing the performance of a foldable display.

Meanwhile, for Example 2, the front phase difference (Rₒ) and color difference (ΔE_{ab}) between the folding part and the unfolding part were measured when the slow axis of a retardation film and the folding axis form an inclined angle of 40°, 45° and 50°, respectively, and the results thereof are shown in Table 2.

TABLE 2

| | | | Gap of Phase | |
|---|---|---|---|---|
| | Phase | Phase | Differences | Color Difference |
| | Difference of | Difference of | Between Folding | Between Folding |
| | Folding Part | Unfolding Part | Part and Unfolding | Part and Unfolding |
| | (nm) | (nm) | Part (nm) | Part (ΔE_{ab}) |
| Inclined Angle 40° | 151.5 | 146.3 | −5.2 | 1.8 |
| Inclined Angle 45° | 145.8 | 144.9 | −0.9 | 0.5 |
| Inclined Angle 50° | 136.1 | 146.3 | 10.2 | 2.9 |

Meanwhile, the gap of phase differences between the folding part and the unfolding part is lowered as the thickness of the retardation film decreases. In the present invention, the retardation film having a thickness of 100 μm or less, preferably 50 μm or less were used. In this regard, the front phase differences (Rₒ) between the folding part and the unfolding part were measured when the thickness of the retardation film is 50 μm, 70 μm and 100 μm, and the results thereof are shown in Table 3.

TABLE 3

| | | | Gap of Phase |
|---|---|---|---|
| | | | Differences |
| | Phase | Phase | Between Folding |
| Thickness of | Difference of | Difference of | Part and Unfolding |
| Retardation | Folding Part | Unfolding Part | Part (the absolute |
| Film (μm) | (nm) | (nm) | value, nm) |
| 50 | 145.8 | 144.9 | 0.9 |
| 70 | 165.1 | 160.4 | 4.7 |
| 100 | 185.8 | 175.4 | 10.1 |

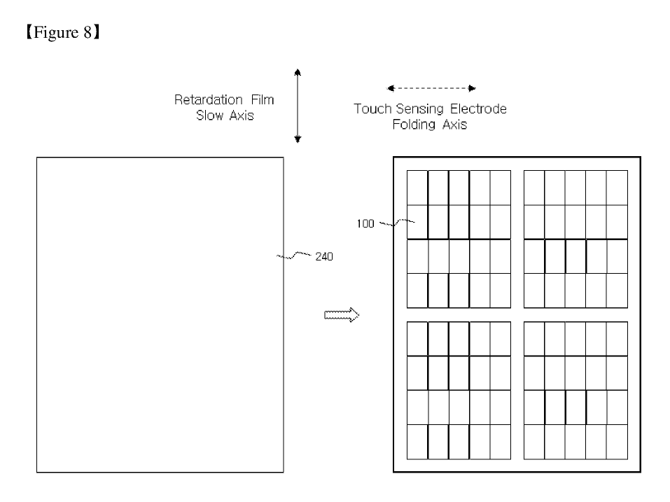

Hereinafter, a method for fabricating the touch sensing electrode with a polarizing plate according to the present invention will be described with reference to FIGS. 8 to 10.

First, FIG. 8 schematically shows a process of fabricating a conventional touch sensing electrode with a polarizing plate by a method known in the art.

Referring to FIG. 8 showing the known method, a plurality of touch sensing electrodes 100 are formed on a transparent substrate by a photolithography process, and a retardation film 240 and a polarizing plate 200 are adhered thereon to fabricate a touch sensing electrode with a polarizing plate.

Specifically, in the case of fabricating a touch sensor using 5.5 G (1,300 mm×1,500 mm) glass, a plurality of square-shaped touch sensing electrodes 100 are formed on a glass of 1,300 mm×1,500 mm by a photolithography process, in which the longitudinal direction of the touch sensing electrodes is identical to that of the glass so as to increase the utilization rate of plate. Accordingly, the folding axis of the touch sensing electrode is formed in the same direction as the longitudinal direction of the glass. Also, on the glass with the touch sensing electrodes formed thereon, the retardation film 240 having the same shape and size (1,300 mm×1,500 mm) as the glass is adhered and the polarizing plate is attached thereon, thereby fabricating a touch sensing electrode with a polarizing plate, in which the folding axis of the touch sensing electrode is substantially identical to the slow axis of the retardation film. In this case, the glass with the touch sensing electrodes formed thereon and the retardation film each have the utilization rate of plate of about 99%. However, the their optical property is deteriorated after bending, as shown in the above experimental results of Examples 1 and 2 and Comparative Examples 1 and 2.

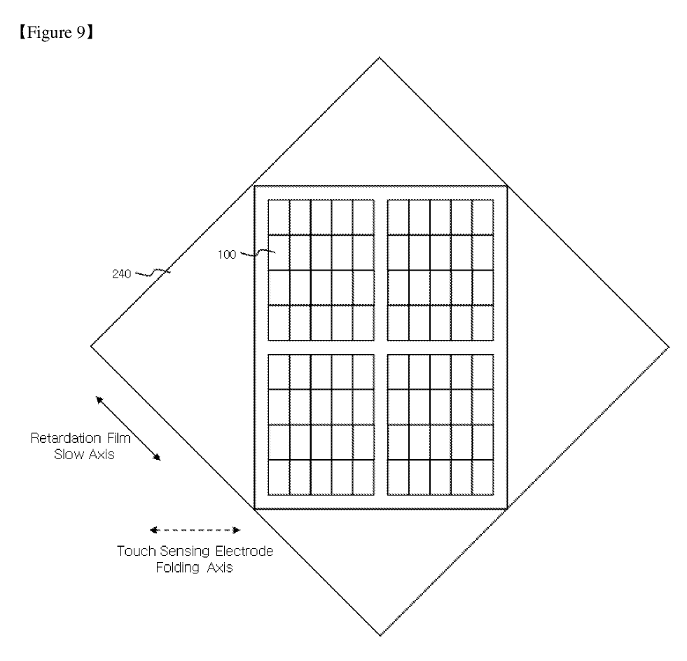

Meanwhile, in order to fabricate the touch sensing electrode with a polarizing plate according to the present invention, the folding axis of the touch sensing electrode and the slow axis of the retardation film forms an inclined angle (40° to 50° , preferably 45°), and in this regard, FIG. 9 schematically shows a process of fabricating the touch sensing electrode with a polarizing plate according to one embodiment of the present invention by a method known in the art.

For example, in the case of fabricating a touch sensor using 5.5 G (1,300 mm×1,500 mm) glass, a plurality of square-shaped touch sensing electrodes 100 are formed on a glass of 1,300 mm×1,500 mm by a photolithography process, in which the longitudinal direction of the touch sensing electrodes is identical to that of the glass so as to increase the utilization rate of plate. Accordingly, the folding axis of the touch sensing electrode is formed in the same direction as the longitudinal direction of the glass. Meanwhile, in order for the folding axis of the touch sensing electrode and the slow axis of the retardation film to form an inclined angle (40° to 50°, preferably 45°), the retardation film 240 should be adhered by forming an inclined angle on the glass with touch sensing electrode thereon. For this, a wide retardation film of 1,980 mm is necessary to cover the whole glass having a size of 1,300 mm×1,500 mm. However, such a wide retardation film of 1,980 mm has not been produced at present, and even if the wide retardation film of 1,980 mm is used, the utilization rate of plate is lowered to 47%, causing high cost.

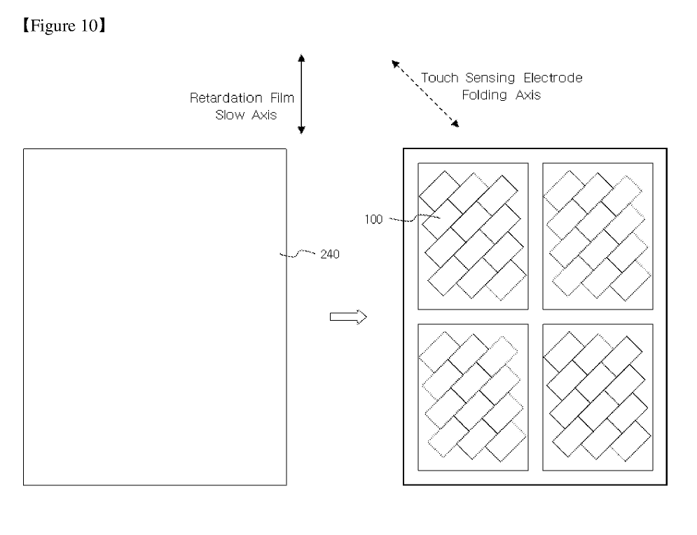

In order to solve this problem, in the fabrication method according to one embodiment of the present invention, a touch sensing electrode is formed on a transparent substrate by a photolithography process so that the original folding axis has an inclined angle. In this regard, FIG. 10 schematically shows a process of fabricating a touch sensing electrode with a polarizing plate according to one embodiment of the present invention by the method of the present invention.

Referring to FIG. 10, as a first method, the retardation film 240 is laminated on a transparent substrate, and then a plurality of touch sensing electrodes 100 are formed thereon by a photolithography process, so that the slow axis of the retardation film has the same direction as the longitudinal direction of the square transparent substrate, and the folding axis of the touch sensing electrode forms an inclined angle (40° to 50° , preferably 45°) with respect to the longitudinal direction of the square transparent substrate. Then, the retardation film with the touch sensing electrode is delaminated from the substrate, and the polarizing plate 200 is attached thereon in the longitudinal direction of the square transparent substrate, thereby fabricating a touch sensing electrode with a polarizing plate in which the folding axis of the touch sensing electrode and the slow axis of the retardation film form an inclined angle.

Meanwhile, as a second method, a plurality of touch sensing electrodes 100 are formed on a transparent substrate by a photolithography process so that the folding axis of the touch sensing electrode forms an inclined angle (40° to 50°, preferably 45°) with respect to the longitudinal direction of the square transparent substrate, and then the touch sensing electrode is transferred on a retardation film so that the slow axis of the retardation film and the folding axis of the touch sensing electrode form an inclined angle. Then, the polarizing plate 200 is attached to the retardation film with the touch sensing electrode, thereby fabricating a touch sensing electrode with a polarizing plate in which the folding axis of the touch sensing electrode and the slow axis of the retardation film form an inclined angle.

For example, in the case of fabricating a touch sensor using 5.5 G (1,300 mm×1,500 mm) glass, a plurality of square-shaped touch sensing electrodes 100 are formed on a glass of 1,300 mm×1,500 mm by a photolithography process forming a mask so that the folding axis of the touch sensing electrode forms an inclined angle (40° to 50°, preferably 45°) with respect to the longitudinal direction of the square glass. Meanwhile, the retardation film 240 having the same shape and size (1,300 mm×1,500 mm) as glass may be laminated to be integrated with the touch sensing electrode prior to the photolithography process (the first method), or it may be integrated with the touch sensing electrode after the photolithography process (the second method). Thereon, the polarizing plate is attached to fabricate a touch sensing electrode with a polarizing plate in which the folding axis of the touch sensing electrode and the slow axis of the retardation film form an inclined angle. In this case, the plate utilization rate of the glass with the touch sensing electrode (the utilization rate of the touch sensing electrodes on the mask) is 80% or more, and the plate utilization rate of the retardation film is about 99%.

Although the present invention has been described in connection with the preferred embodiments, the embodiments of the present invention are only for illustrative purposes and should not he construed as limiting the scope of the present invention.

It will he understood by those skilled in the art that various changes and modifications can be made thereto within the technical spirit and scope defined by the appended claims.

### EXPLANATION OF REFERENCE NUMERALS

100: Touch Sensing Electrode

200: Polarizing Plate

210: Protective Film

220: Polarizer

230: Adhesive

1. A touch sensing electrode with a polarizing plate, comprising:
a touch sensing electrode capable of being folded and unfolded on its folding axis;
a retardation film disposed on the touch sensing electrode and having a slow axis that forms an inclined angle with the folding axis; and
a polarizing plate disposed on the retardation film.

2. The touch sensing electrode with a polarizing plate of claim 1, wherein the inclined angle ranges from 40 to 50°.

3. The touch sensing electrode with a polarizing plate of claim 2, wherein the inclined angle is 45°.

4. The touch sensing electrode with a polarizing plate of claim 1, wherein the retardation film has a thickness of 100 λm or less.

5. The touch sensing electrode with a polarizing plate of claim 4, wherein the retardation film has a thickness of 50 μm or less.

6. The touch sensing electrode with a polarizing plate of claim 1, wherein the retardation film has inverse wavelength dispersibility that provides a low refractive index for short wavelength area and a high refractive index for long wavelength area.

7. The touch sensing electrode with a polarizing plate of claim 1, which has a gap of phase differences of 10 nm or less between a folding part and an unfolding part when the touch sensing electrode is folded on the folding axis.

8. The touch sensing electrode with a polarizing plate of claim 7, which has a gap of phase differences of 5 nm or less between a folding part and an unfolding part when the touch sensing electrode is folded on the folding axis.

9. A display device, comprising the touch sensing electrode with a polarizing plate of claim 1.

10. A method for fabricating a touch sensing electrode with a polarizing plate, comprising:
laminating a retardation film on a substrate;
forming a touch sensing electrode capable of being folded and unfolded on its folding axis on the retardation film;
delaminating the retardation film with the touch sensing electrode from the substrate; and
attaching a polarizing plate to the retardation film with the touch sensing electrode,
wherein the retardation film has a slow axis that forms an inclined angle with the folding axis.

11. A method for fabricating a touch sensing electrode with a polarizing plate, comprising:
forming a touch sensing electrode capable of being folded and unfolded on its folding axis on a substrate;
transferring the touch sensing electrode on a retardation film; and
attaching a polarizing plate to the retardation film with the touch sensing electrode,
wherein the retardation film has a slow axis that forms an inclined angle with the folding axis.

12. The method of claim 10, wherein the step of forming the touch sensing electrode comprises carrying out a photolithography process of the touch sensing electrode so that the folding axis forms an inclined angle with respect to the longitudinal direction of the substrate having a square shape.

13. The method of claim 10, wherein the inclined angle ranges from 40 to 50°.

14. The method of claim 13, wherein the inclined angle is 45°.

15. The method of claim 11, wherein the step of forming the touch sensing electrode comprises carrying out a photolithography process of the touch sensing electrode so that the folding axis forms an inclined angle with respect to the longitudinal direction of the substrate having a square shape.

16. The method of claim 11, wherein the inclined angle ranges from 40° to 50°.

17. The method of claim 16, wherein the inclined angle is 45°.
